(19) United States
(12) Patent Application Publication
(10) Pub. No.: US 2021/0217191 A1
(43) Pub. Date: Jul. 15, 2021

(54) IMAGE PROCESSING DEVICE, IMAGE PROCESSING METHOD, PROGRAM, AND INFORMATION PROCESSING SYSTEM

(71) Applicant: SONY CORPORATION, TOKYO (JP)

(72) Inventors: SHUN KAIZU, KANAGAWA (JP); YASUTAKA HIRASAWA, TOKYO (JP); TEPPEI KURITA, TOKYO (JP)

(21) Appl. No.: 16/769,159

(22) PCT Filed: Oct. 12, 2018
(86) PCT No.: PCT/JP2018/038078

§ 371 Date: Jun. 2, 2020

(30) Foreign Application Priority Data
Dec. 12, 2017 (JP) 2017-237586

(51) Int. Cl. G06T 7/593

(52) U.S. Cl. CPC G06T 7/593; G06T 2207/10012

(57) ABSTRACT

A local match processing section 361 of a parallax detecting section 36 generates a cost volume indicating a cost indicating, for each pixel and each parallax, the similarity between images acquired by imaging sections 21 and 22 that are different in viewpoint positions. A cost volume processing section 363 performs cost adjustment processing on a cost volume on the basis of a polarization image acquired by the imaging section 21, by using normal line information generated for each pixel by a normal line information generating section 31. A minimum value search processing section 365 detects, from the cost volume having undergone the cost adjustment processing, a parallax at which the similarity becomes maximum, by using the parallax-based costs of a parallax detection target pixel. A depth calculating section 37 generates depth information indicating depths of respective pixels on the basis of parallaxes detected, for the respective pixels, by the parallax detecting section 36. This enables detection of a parallax with high precision almost without the influences of an object shape, an image capturing condition, and the like.

### TECHNICAL FIELD

The present technology relates to an image processing device, an image processing method, a program, and an information processing system, and enables detection of a parallax with high precision.

### BACKGROUND ART

Conventionally, depth information has been acquired by using polarization information. For example, an image processing device disclosed in PTL 1 performs positioning of polarization images obtained from a plurality of viewpoints by using depth information (a depth map) that indicates a distance to an object that is generated by a stereo matching process in which captured multi-viewpoint images are used. In addition, the image processing device generates normal line information (a normal line map) on the basis of polarization information detected by use of the positioned polarization images. Moreover, the image processing device increases the precision of the depth information by using the generated normal line information.

Further, NPL 1 describes generating depth information with high precision by using normal line information obtained on the basis of polarization information and depth information obtained by a ToF (Time of Flight) sensor.

### CITATION LIST

### Patent Literature

### [PTL 1]

PCT Patent Publication No. WO2016/088483

### Non-Patent Literature

### [NPL 1]

Achuta Kadamb, et al. “Polarized 3D: High-Quality Depth Sensing with Polarization Cues”. ICCV (2015).

### SUMMARY

### Technical Problems

Incidentally, the image processing device disclosed in PTL 1 generates depth information on the basis of a parallax detected by a stereo matching process in which captured multi-viewpoint images are used. For this reason, precise detection of a parallax in a flat portion through the stereo matching process is difficult, whereby there is a possibility that depth information cannot be obtained with high precision. In the case where a ToF sensor is used as in NPL 1, depth information cannot be obtained under a condition where no projection light arrives or a condition where return light is hardly detected. Further, the power consumption becomes large because projection light is needed.

Therefore, an object of the present technology is to provide an image processing device, an image processing method, a program, and an information processing system for enabling precise detection of a parallax almost without the influences of an object shape, an image capturing condition, and the like.

### Solution to Problems

A first aspect of the present technology is an image processing device including:
a parallax detecting section that performs, by using normal line information in respective pixels based on a polarization image, cost adjustment processing on a cost volume indicating, for each pixel and each parallax, a cost corresponding to a similarity among multi-viewpoint images including the polarization image, and detects, from the cost volume having undergone the cost adjustment processing, a parallax at which the similarity becomes maximum, by using parallax-based costs of a parallax detection target pixel.

In this technology, the parallax detecting section performs, by using normal line information in respective pixels based on a polarization image, the cost adjustment processing on the cost volume indicating, for each pixel and each parallax, a cost corresponding to the similarity among multi-viewpoint images including the polarization image. In the cost adjustment processing, cost adjustment of the parallax detection target pixel is performed on the basis of a cost calculated, with use of normal line information in the parallax detection target pixel, for a pixel in a peripheral region based on the parallax detection target pixel. Also, in the cost adjustment, at least one of weighting in accordance with the normal line difference between normal line information in the parallax detection target pixel and normal line information in a pixel in the peripheral region, weighting in accordance with the distance between the parallax detection target pixel and the pixel in the peripheral region, or weighting in accordance with the difference between a luminance value of the parallax detection target pixel and a luminance value of the pixel in the peripheral region, may be performed on the cost calculated for the pixel in the peripheral region.

The parallax detecting section performs the cost adjustment processing for each of normal line directions among which indefiniteness is generated on the basis of normal line information, and detects a parallax at which the similarity becomes maximum, by using the cost volume having undergone the cost adjustment processing performed for each of the normal line directions. Further, the cost volume is generated with each parallax used as a prescribed pixel unit, and on the basis of a cost in a prescribed parallax range based on a parallax of a prescribed pixel unit at which the similarity becomes maximum, the parallax detecting section detects a parallax at which the similarity becomes maximum with a resolution higher than the prescribed pixel unit. Moreover, a depth information generating section is provided to generate depth information on the basis of the parallax detected by the parallax detecting section.

A second aspect of the present technology is an image processing method including:
performing, by using normal line information in respective pixels based on a polarization image, cost adjustment processing on a cost volume indicating, for each pixel and each parallax, a cost corresponding to a similarity among multi-viewpoint images including the polarization image, and detecting, from the cost volume having undergone the cost adjustment processing, a parallax at which the similarity becomes maximum, by using parallax-based costs of a parallax detection target pixel.

A third aspect of the present technology is a program for causing a computer to process multi-viewpoint images including a polarization image, the program for causing the computer to execute:
a procedure of performing, by using normal line information in respective pixels based on the polarization image, cost adjustment processing on a cost volume indicating, for each pixel and each parallax, a cost corresponding to a similarity among the multi-viewpoint images including the polarization image, and
a procedure of detecting, from the cost volume having undergone the cost adjustment processing, a parallax at which the similarity becomes maximum, by using parallax-based costs of a parallax detection target pixel.

It is to be noted that the program according to the present technology can be provided by a recording medium such as an optical disk, a magnetic disk, or a semiconductor memory, or a communication medium such as a network, for providing various program codes in a computer-readable format to a general-purpose computer capable of executing the various program codes. As a result of provision of such a program in a computer-readable format, a process corresponding to the program can be executed in a computer.

A fourth aspect of the present technology is an information processing system including:
an imaging section that acquires multi-viewpoint images including a polarization image,
a parallax detecting section that performs, by using normal line information in respective pixels based on the polarization image, cost adjustment processing on a cost volume indicating, for each pixel and each parallax, a cost corresponding to a similarity among the multi-viewpoint images including the polarization image, and detects, from the cost volume having undergone the cost adjustment processing, a parallax at which the similarity becomes maximum, by using parallax-based costs of a parallax detection target pixel, and
a depth information generating section that generates depth information on the basis of the parallax detected by the parallax detecting section.

### Advantageous Effect of Invention

According to the preset technology, cost adjustment processing is executed, for each pixel and each parallax, on a cost volume indicating a cost corresponding to the similarity among multi-viewpoint images including a polarization image, with use of normal line information that is obtained for each pixel and that is based on the polarization image so that, from the cost volume having undergone the cost adjustment processing, a parallax at which the similarity becomes maximum is detected with use of parallax-based costs of a parallax detection target pixel. Therefore, the parallax can be precisely detected almost without the influences of an object shape, an image capturing condition, and the like. It is to be noted that the effects described herein are just examples, and thus, are not limitative. Additional effects may be further provided.

### BRIEF DESCRIPTION OF DRAWINGS

FIG. 1 is a diagram depicting a configuration of a first embodiment of an information processing system according to the present technology.

FIG. 2 depicts configurations of an imaging section 21.

FIG. 3 is a diagram for explaining operation of a normal line information generating section 31.

FIG. 4 is a diagram depicting a relationship between a luminance and a polarization angle.

FIG. 5 is a diagram depicting a configuration of a depth information generating section 35.

FIG. 6 is a diagram for explaining operation of a local match processing section 361.

FIG. 7 is a diagram for explaining a cost volume generated by the local match processing section 361.

FIG. 8 is a diagram depicting a configuration of a cost volume processing section 363.

FIG. 9 is a diagram for explaining operation of calculating a parallax in a peripheral pixel.

FIG. 10 is a diagram for explaining operation of calculating a cost C_{j,dNj} at a parallax dNj.

FIG. 11 is a diagram for explaining operation of detecting a parallax at which a cost becomes minimum.

FIG. 12 is a diagram depicting a case having indefiniteness among normal lines.

FIG. 13 is a diagram depicting an example of a parallax-based cost of a process target pixel.

FIG. 14 is a diagram depicting arrangement of the imaging section 21 and an imaging section 22.

FIG. 15 is a flowchart depicting operation of an image processing device.

FIG. 16 is a diagram depicting an example configuration of a second embodiment of the information processing system according to the present technology.

FIG. 17 is a diagram depicting an example configuration of a depth information generating section 35a.

FIG. 18 is a block diagram depicting an example of schematic configuration of a vehicle control system.

FIG. 19 is a diagram of assistance in explaining an example of installation positions of an outside-vehicle information detecting section and an imaging section.

### DESCRIPTION OF EMBODIMENTS

Hereinafter, embodiments for implementing the present technology will be explained. It is to be noted that the explanation will be given in accordance with the following order.
1. First Embodiment
   1-1. Configuration of First Embodiment
   1-2. Operation of Each Section
2. Second Embodiment
   2-1. Configuration of Second Embodiment
   2-2. Operation of Each Section
3. Other Embodiments
4. Examples of Application

### 1. First Embodiment

### 1-1. Configuration of First Embodiment

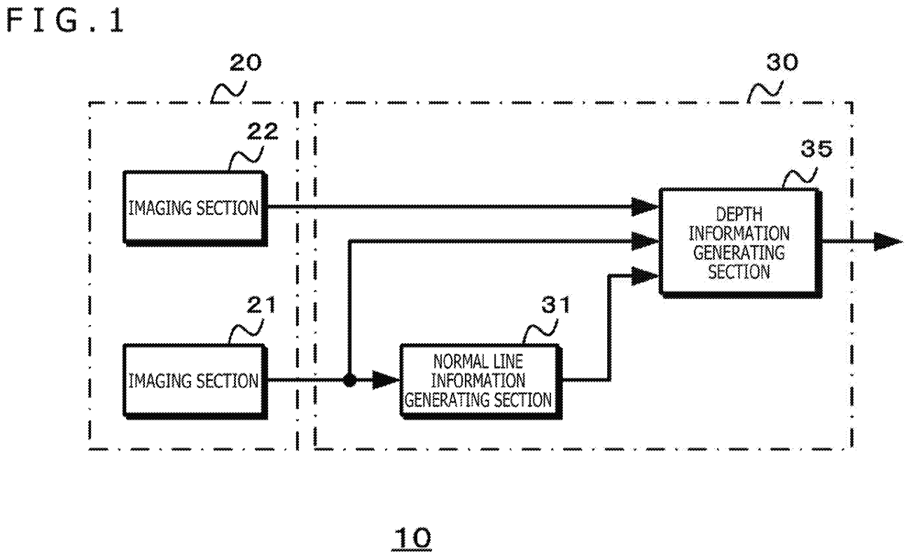

FIG. 1 depicts a configuration of a first embodiment of an information processing system according to the present technology. An information processing system 10 is constituted by using an imaging device 20 and an image processing device 30. The imaging device 20 includes a plurality of imaging sections such as imaging sections 21 and 22. The image processing device 30 includes a normal line information generating section 31 and a depth information generating section 35.

The imaging section 21 outputs a polarization image signal, which is obtained by capturing an image of a desired object, to the normal line information generating section 31 and the depth information generating section 35. Further, the imaging section 22 generates a polarization image signal or non-polarization image signal obtained by capturing an image of the desired object from a viewpoint that is different from that of the imaging section 21, and outputs the signal to the depth information generating section 35.

The normal line information generating section 31 of the image processing device 30 generates normal line information indicating a normal direction for each pixel on the basis of the polarization image signal supplied from the imaging section 21, and outputs the normal line information to the depth information generating section 35.

The depth information generating section 35 calculates, for each pixel and each parallax, a cost indicating the similarity among images by using two image signals taken from different viewpoints and supplied from the imaging section 21 and the imaging section 22, thereby generates a cost volume. Further, the depth information generating section 35 performs cost adjustment processing on the cost volume by using the image signal supplied from the imaging section 21 and the normal line information generated by the normal line information generating section 31. The depth information generating section 35 detects, from the cost volume having undergone the cost adjustment processing, a parallax at which the similarity becomes maximum by using parallax-based costs of a parallax detection target pixel. For example, the depth information generating section 35 performs a filtering process for each pixel and each parallax by using normal line information in a process target pixel and a pixel in a peripheral region based on the process target pixel having undergone the cost adjustment processing so that the cost adjustment processing on the cost volume is accomplished. Further, the depth information generating section 35 may calculate a weight on the basis of the difference in normal lines, the positional difference, and the luminance difference between the process target pixel and the pixel in the peripheral region, and performs a filtering process for each pixel and each parallax by using the calculated weight and the normal line information generated by the normal line information generating section 31 so that the cost adjustment processing on the cost volume is accomplished. The depth information generating section 35 calculates a depth for each pixel, from the detected parallax and the baseline length and focal distance between the imaging section 21 and the imaging section 22, thereby generates depth information.

### 1-2. Operation of Each Section

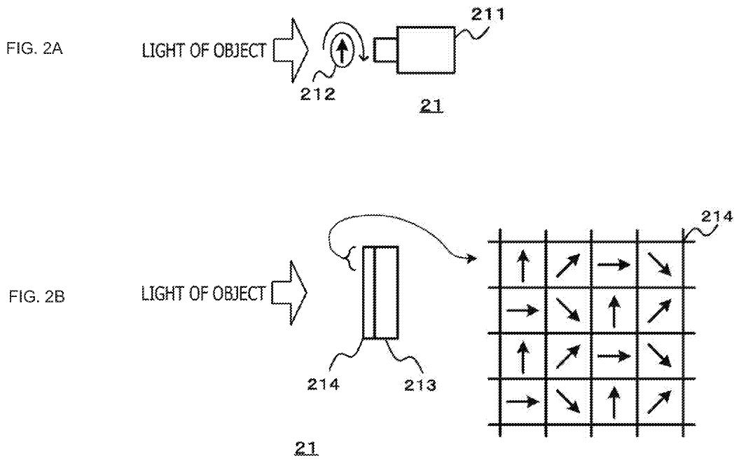

Next, operation of each of the sections of the imaging device 20 will be explained. The imaging section 21 generates a polarization image signal in which three or more polarization directions are used. FIG. 2 depicts configurations of the imaging section 21. For example, FIG. 2(a) depicts a configuration in which a polarization plate 212 is disposed in front of a camera block 211 including an imaging optical system including an imaging lens, etc., an image sensor, and the like. The imaging section 21 having this configuration captures an image while rotating the polarization plate 212, and generates image signals (hereinafter, referred to as “polarization image signals”) for each of polarization directions whose number is three or more. FIG. 2(b) depicts a configuration in which a polarizer 214 for providing polarization pixels such that the polarization characteristics can be calculated is disposed on an incident surface of an image sensor 213. It is to be noted that any one of four polarization directions is set for each pixel in FIG. 2(b). The polarization pixels are not limited to those each having any one of the four polarization directions as depicted in FIG. 2(b), and any one of three polarization directions may be set for each of the polarization pixels. Alternatively, non-polarization pixels and polarization pixels for each of which either one of two different polarization directions is set may be provided such that the polarization characteristics can be calculated. In the case where the imaging section 21 has the configuration depicted in FIG. 2(b), pixel values in pixel positions at which different polarization directions are set are calculated by an interpolation process or a filtering process using pixels for which the same polarization direction is set, whereby image signals generated, for respective polarization directions, by the configuration depicted in FIG. 2(a) can be generated. It is to be noted that it is sufficient that the imaging section 21 can generate polarization image signals, and thus, the imaging section 21 is not limited to the configurations depicted in FIG. 2. The imaging section 21 outputs the polarization image signals to the image processing device 30.

The imaging section 22 may have a configuration similar to that of the imaging section 21, or may have a configuration using no polarization plate 212 or no polarizer 214. The imaging section 22 outputs the generated image signals (or polarization image signals) to the image processing device 30.

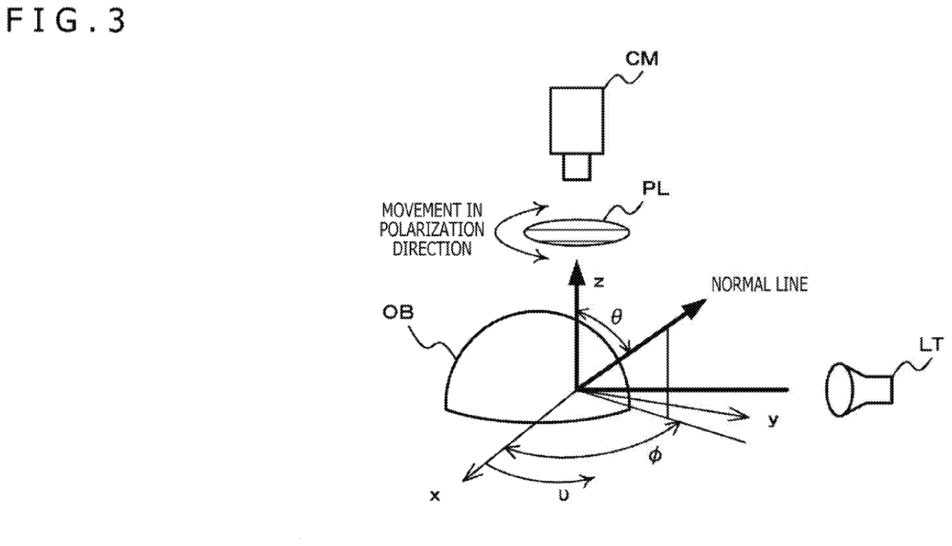

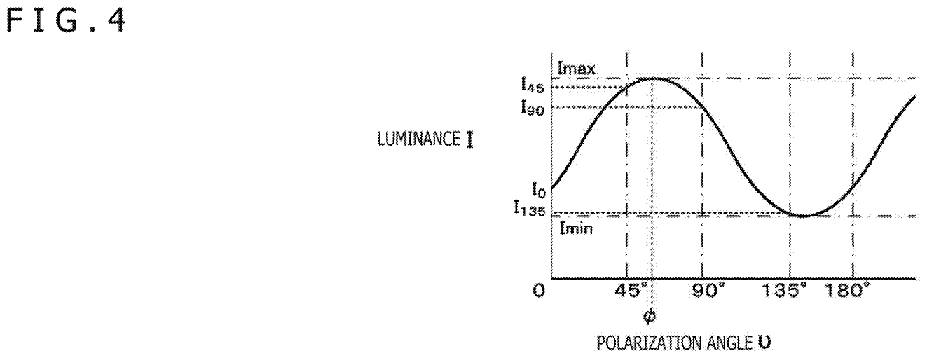

The normal line information generating section 31 of the image processing device 30 acquires a normal line on the basis of the polarization image signals. FIG. 3 is a diagram for explaining operation of the normal line information generating section 31. As depicted in FIG. 3, an object OB is illuminated with use of a light source LT, for example, and an imaging section CM captures an image of the object OB through a polarization plate PL. In this case, in the captured image, the luminance of the object OB varies depending on the polarization direction of the polarization plate PL. It is to be noted that the highest luminance is defined as Imax, and the lowest luminance is defined as Imin. Further, an x-axis and a y-axis of two-dimensional coordinates are set on the plane of the polarization plate PL, and an angle of the y-axis direction with respect to the x-axis is defined as a polarization angle U which indicates the polarization direction (angle of a transmission axis) of the polarization plate PL. The polarization plate PL has a 180-degree cycle in which the original polarization state is restored by rotation of the polarization direction by 180 degrees. In addition, the polarization angle U obtained when the maximum luminance Imax is observed is defined as an azimuth angle cp. As a result of this definition, when the polarization direction of the polarization plate PL is changed, the luminance I(U) which can be expressed by a polarization model expression indicated in Expression (1) is observed. It is to be noted that FIG. 4 depicts an example of the relationship between the luminance and the polarization angle. Parameters A, B, C in Expression (1) each represent a Sin waveform obtained by polarization. Here, for example, the luminance values in four polarization directions are set as follows: the observation value when the polarization angle U is set to “U=0 degree” is defined as luminance value I0, the observation value when the polarization angle U is set to “U=45 degrees” is defined as luminance value I45, the observation value when the polarization angle U is set to “U=90 degrees” is defined as luminance value I90, and the observation value when the polarization angle U is set to “U=135 degrees” is defined as luminance value I135. The parameter A is calculated on the basis of Expression (2), the parameter B is calculated on the basis of Expression (3), and the parameter C is calculated on the basis of Expression (4). It is to be noted that, since three parameters is given in the polarization model expression, the parameters A, B, and C may be calculated using the luminance values in three polarization directions, but a detailed explanation thereof is omitted.

$$\begin{matrix}[ Math . 1 ] & \\ I ( υ ) = A \cdot sin 2 υ + B \cdot cos 2 υ + C & ( 1 ) \\ A = \frac{{I}_{45} - {I}_{135}}{2} & ( 2 ) \\ B = \frac{{I}_{0} - {I}_{90}}{2} & ( 3 ) \\ C = \frac{{I}_{0} + {I}_{45} + {I}_{90} + {I}_{135}}{4} & ( 4 )\end{matrix}$$

When the coordinate system is changed from the polarization model expression indicated in Expression (1), Expression (5) is obtained. A polarization degree ρ in Expression (5) is calculated on the basis of Expression (6), and an azimuth angle φ in Expression (5) is calculated on the basis of Expression (7). It is to be noted that the polarization degree ρ represents an amplitude of the polarization model expression, and the azimuth angle φ represents a phase of the polarization model expression.

$$\begin{matrix}[ Math . 2 ] & \\ I ( υ ) = C \cdot ( 1 + ρ \cdot cos ( 2 ( υ - ϕ ) ) & ( 5 ) \\ ρ = \frac{\sqrt{{A}^{2} + {B}^{2}}}{C} & ( 6 ) \\ ϕ = \frac{1}{2} {tan}^{- 1} ( \frac{A}{B} ) & ( 7 )\end{matrix}$$

Moreover, it has been known that a zenith angle θ can be calculated on the basis of Expression (8) using a polarization degree ρ and a refractive index n of an object. It is to be noted that, in Expression (8), a coefficient k0 is calculated on the basis of Expression (9), and k1 is calculated on the basis of Expression (10). Further, the coefficients k2 and k3 are calculated on the basis of expressions (11) and (12), respectively.

$$\begin{matrix}[ Math . 3 ] & \\ θ = {sin}^{- 1} ( \sqrt{- {k}_{1} \frac{{k}_{2} ( {k}_{0} + {k}_{1} ) - \sqrt{{{k}_{2}^{2} ( {k}_{0} + {k}_{1} )}^{2} - {k}_{2}^{2} ( {k}_{0}^{2} - {k}_{1}^{2} )}}{2 ( {k}_{0}^{2} - {k}_{1}^{2} )}} ) & ( 8 ) \\ {k}_{0} = 2 ( 1 - ρ ) - ( 1 + ρ ) ( {n}^{2} + \frac{1}{{n}^{2}} ) & ( 9 ) \\ {k}_{1} = 4 ρ & ( 10 ) \\ {k}_{2} = 1 + {n}^{2} & ( 11 ) \\ {k}_{3} = 1 - {n}^{2} & ( 12 )\end{matrix}$$

Therefore, the normal line information generating section 31 can generate normal line information N (Nx, Ny, Nz) by calculating the azimuth angle φ and the zenith angle θ through the above calculation. Nx in the normal line information N represents an x-axis direction component, and is calculated on the basis of Expression (13). Further, Ny is a y-axis direction component, and is calculated on the basis of Expression (14). Moreover, Nz represents a z-axis direction component, and is calculated on the basis of Expression (15).

Nx=cos(φ)·sin(θ) (13)

Ny=sin(φ)·sin(θ) (14)

Nz=cos(θ) (15)

The normal line information generating section 31 generates the normal line information N for each pixel, and outputs the normal line information generated for each pixel to the depth information generating section 35.

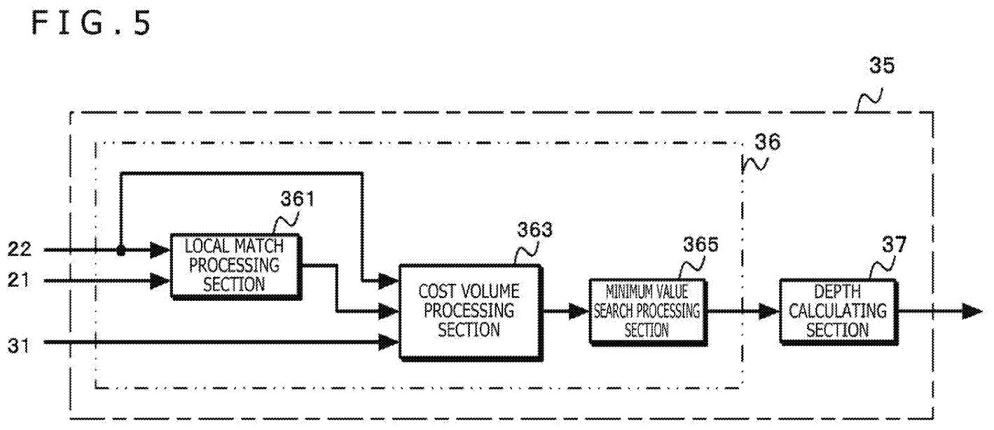

FIG. 5 depicts a configuration example of the depth information generating section 35. The depth information generating section 35 includes a parallax detecting section 36 and a depth calculating section 37. In addition, the parallax detecting section 36 includes a local match processing section 361, a cost volume processing section 363, and a minimum value search processing section 365.

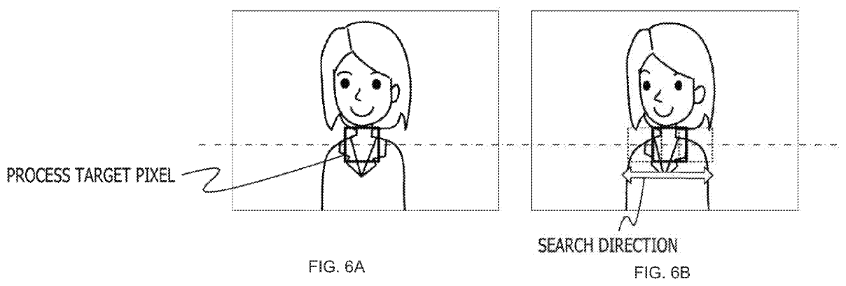

The local match processing section 361 detects, for each pixel in one captured image, a corresponding point in the other captured image by using image signals generated by the imaging sections 21 and 22. FIG. 6 is a diagram for explaining operation of the local match processing section 361. FIG. 6(a) depicts a left viewpoint image acquired by the imaging section 21. FIG. 6(b) depicts a right viewpoint image acquired by the imaging section 22. The imaging section 21 and the imaging section 22 are arranged side by side in the horizontal direction such that the respective positions, in the vertical direction, of the imaging section 21 and the imaging section 22 match each other. The local match processing section 361 detects, from the right viewpoint image, a corresponding point to a process target pixel in the left viewpoint image. Specifically, as a reference position, the local match processing section 361 regards a pixel position, in the right viewpoint image, the same in the vertical direction as that of a process target pixel in the left viewpoint image. For example, as the reference position, the local match processing section 361 regards a pixel position, in the right viewpoint image, located at a position same as the position of the process target pixel in the left viewpoint image. In addition, the local match processing section 361 sets a search direction to the horizontal direction in which the imaging section 22 is arranged with respect to the imaging section 21. The local match processing section 361 calculates a cost indicating the similarity between the process target pixel and a pixel in a search range. The local match processing section 361 may use, as the cost, an absolute difference calculated by pixel base indicated in Expression (16), for example, or may use, as the cost, a zero-mean sum of an absolute difference calculated by window base indicated in Expression (17). Further, another statistical amount such as a mutual correlation coefficient may be used for the cost indicating the similarity.

[Math. 4]

C_{AD}(i,d)=|Lᵢ−R_{i+d}| (16)

C_{ZSAD}(i,d)=Σ_{(x,y)}|(L_{xy}−L̅ᵢ̅)−(R_{x+d,y}−R̅_̅{̅i̅+̅d̅}̅) (17)

In Expression (16), “Li” represents a luminance value of a process target pixel i in a left viewpoint image, and “d” represents a pixel unit distance from a reference position in a right viewpoint image, and corresponds to the parallax. “Ri+d” represents a luminance value of a pixel at which the parallax d from the reference position in the right viewpoint image is generated. Further, in Expression (17), “x, y” represents a position in a window, the bar Li represents an average luminance value in a peripheral region based on the process target pixel i, and the bar Ri+d represents an average luminance value in a peripheral region based on the position at which the parallax d from the reference position is generated. In addition, in the case where Expression (16) or (17) is used, when the calculated value is smaller, the similarity is higher.

In addition, a non-polarization image signal is supplied from the imaging section 22 to the local match processing section 361, the local match processing section 361 generates a non-polarization image signal on the basis of a polarization image signal supplied from the imaging section 21, and performs a local matching process. For example, since the aforementioned parameter C represents a non-polarization light component, the local match processing section 361 uses, as a non-polarization image signal, a signal indicating the pixel-based parameter C. Moreover, since usage of the polarization plate and the polarizer results in deterioration of sensitivity, the local match processing section 361 may perform gain adjustment on the non-polarization image signal generated from the polarization image signal such that the sensitivity equal to that obtained from the non-polarization image signal from the imaging section 22 can be obtained.

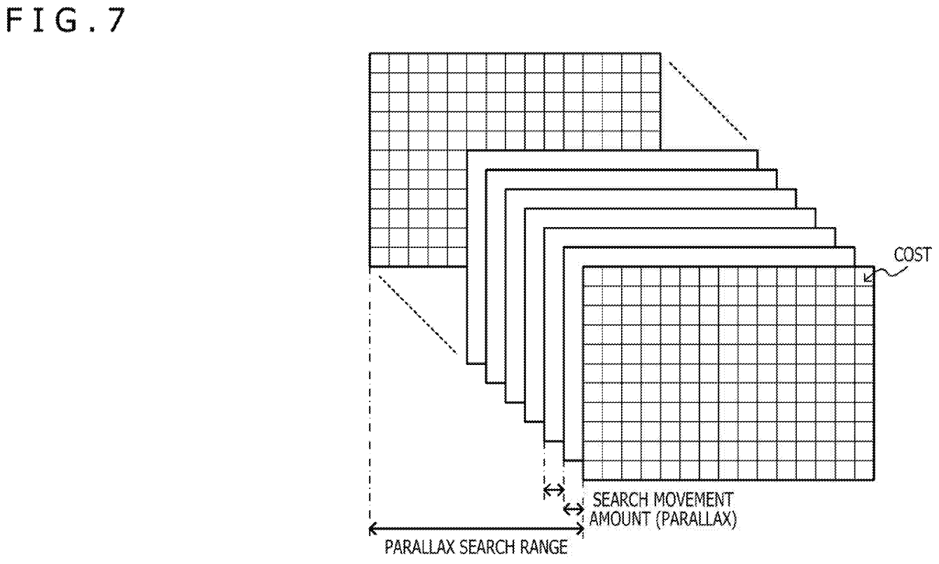

The local match processing section 361 generates a cost volume by calculating a similarity for each pixel in the left viewpoint image and for each parallax. FIG. 7 is a diagram for explaining a cost volume generated by the local match processing section 361. In FIG. 7, similarities calculated, at the same parallax, for respective pixels in the left viewpoint image are indicated by one plane. Therefore, a plane indicating the similarities calculated for respective pixels in the left viewpoint image is provided for each search movement amount (parallax) in a parallax search range, whereby a cost volume is formed. The local match processing section 361 outputs the generated cost volume to the cost volume processing section 363.

The cost volume processing section 363 performs cost adjustment processing on the cost volume generated by the local match processing section 361 such that parallax detection can be performed with high precision. The cost volume processing section 363 performs the cost adjustment processing on the cost volume by performing, for each pixel and each parallax, a filtering process with use of normal line information regarding a process target pixel for the cost adjustment processing and a pixel in a peripheral region based on the process target pixel. Alternatively, the depth information generating section 35 may perform the cost adjustment processing on the cost volume by calculating a weight on the basis of the normal line difference, positional difference, and luminance difference between the process target pixel and a pixel in the peripheral region, and by performing, for each pixel and each parallax, a filtering process with use of the calculated weight and the normal line information generated by the normal line information generating section 31.

Next, a case of calculating a weight on the basis of the normal line difference, the positional difference, and the luminance difference between a process target pixel and a pixel in a peripheral region, and performing a filtering process with use of the calculated weight and the normal line information generated by the normal line information generating section 31, will be explained.

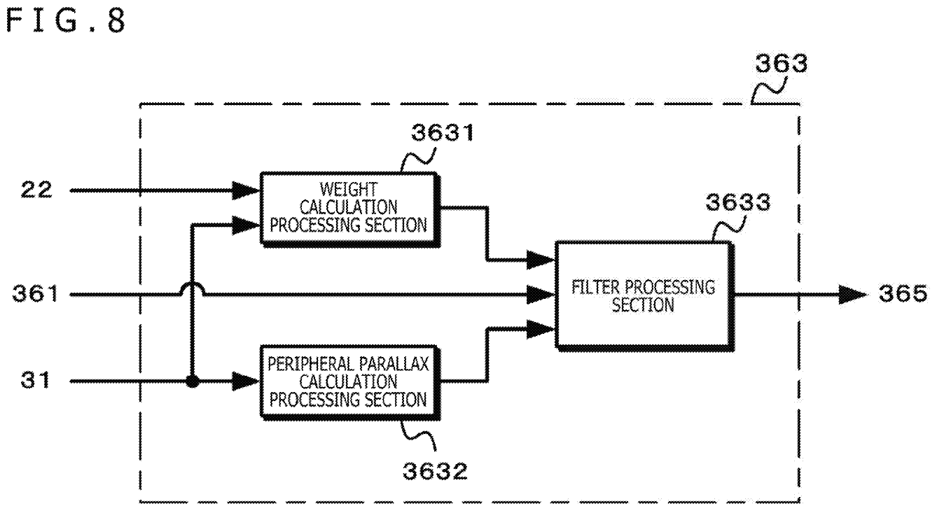

FIG. 8 depicts a configuration of the cost volume processing section 363. The cost volume processing section 363 includes a weight calculation processing section 3631, a peripheral parallax calculation processing section 3632, and a filter processing section 3633.

The weight calculation processing section 3631 calculates a weight according to the normal line information, the positions, and the luminances of a process target pixel and a peripheral pixel. The weight calculation processing section 3631 calculates a distance function value on the basis of the normal line information regarding the process target pixel and the peripheral pixel, and calculates the weight for the peripheral pixel by using the calculated distance function value and the positions and/or luminances of the process target pixel and a pixel in the peripheral region.

The weight calculation processing section 3631 calculates a distance function value by using the normal line information regarding the process target pixel and the peripheral pixel. For example, it is assumed that normal line information Ni=(N_{i,x}, N_{i,z}) is about a process target pixel i, and normal line information Nj=N_{j,x}, N_{j,y}, N_{j,z}) is about a peripheral pixel j. In this case, the distance function value dist(Ni−Nj) of the process target pixel i and the peripheral pixel j in a peripheral region are calculated by Expression (18) to indicate the normal line difference.

[Math. 5]

diSt(Nᵢ,Nᵢ)=\sqrt{(N_{i,x}−N_{j,x})²+(N_{i,y}−N_{j,y})²+(N_{i,z}−N_{j,z})²} (18)

By using the distance function value dist(Ni−Nj) and using, for example, a position Pi of the process target pixel i and a position Pj of the peripheral pixel j, the weight calculation processing section 3631 calculates a weight W_{i,j} for the peripheral pixel with respect to the process target pixel on the basis of Expression (19). It is to be noted that, in Expression (19), a parameter σs represents a parameter for adjusting a space similarity, a parameter σn represents a parameter for adjusting a normal line similarity, and a parameter Ki represents a normalized term. The parameters σs, σn, Ki are previously set.

$$\begin{matrix}[ Math . 6 ] & \\ {W}_{i , j} = \frac{1}{{K}_{i}} exp ( - \frac{{( {P}_{i} - {P}_{j} )}^{2}}{{σ}_{s}^{2}} ) exp ( - \frac{{dist ( {N}_{i} - {N}_{j} )}^{2}}{{σ}_{n}^{2}} ) & ( 19 )\end{matrix}$$

In addition, by using the distance function value dist(Ni−Nj), the position Pi and a luminance value Ii of the process target pixel i, and the position Pj and a luminance value Ij of the peripheral pixel j, the weight calculation processing section 3631 may calculate the weight W_{i,j} for the pixel in the peripheral region on the basis of Expression (20). It is to be noted that, in Expression (20), a parameter σc represents a parameter for adjusting a luminance similarity. The parameter σc is previously set.

$$\begin{matrix} [ Math . 7 ] & \\ {W}_{i , j} = \frac{1}{{K}_{i}} exp ( - \frac{{( {P}_{i} - {P}_{j} )}^{2}}{{σ}_{s}^{2}} ) exp ( - max ( \frac{{( {I}_{i} - {I}_{j} )}^{2}}{{σ}_{c}^{2}} , \frac{{dist ( {N}_{i} - {N}_{j} )}^{2}}{{σ}_{n}^{2}} ) ) & ( 20 )\end{matrix}$$

The weight calculation processing section 3631 calculates respective weights for the peripheral pixels relative to the process target pixel, and outputs the weights to the filter processing section 3633.

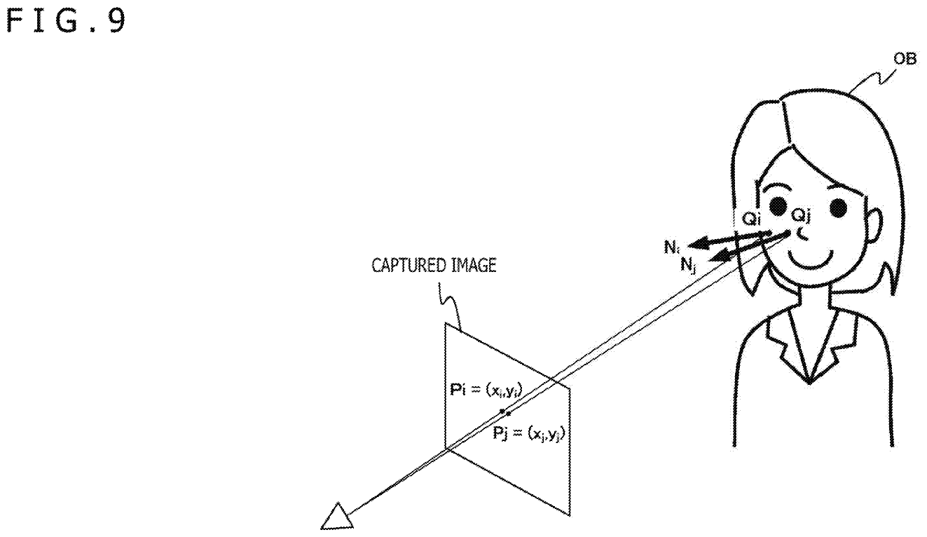

The peripheral parallax calculation processing section 3632 calculates a parallax in a peripheral pixel relative to the process target pixel. FIG. 9 is a diagram for explaining operation for calculating a parallax in a peripheral pixel. When an imaging plane is an x-y plane, the position Pi (=xᵢ, xⱼ) of a process target pixel corresponds to a position Qi of an object OB, and a position Pj (=xⱼ, yⱼ) of a peripheral pixel corresponds to a position Qj of the object OB. By using the position Pi of the process target pixel i, that is, normal line information Ni=(N_{i,x}, N_{i,y}, N_{i,z}) at the position Qi of the object OB, using the position Pj of the peripheral pixel j, that is, normal line information Nj=(N_{j,x}, N_{j,y}, N_{j,z}) at the position Qj of the object OB and using a parallax di, the peripheral parallax calculation processing section 3632 calculates a parallax dNj in the peripheral pixel j on the basis of Expression (21).

$$\begin{matrix}[ Math . 8 ] & \\ dNj = di * \frac{{N}_{i , x} * {x}_{i} + {N}_{i , y} * {y}_{i} + {N}_{i , z} * f}{{N}_{i , x} * {x}_{j} + {N}_{i , y} * {y}_{j} + {N}_{i , z} * f} & ( 21 )\end{matrix}$$

The peripheral parallax calculation processing section 3632 calculates a parallax dNj for each of peripheral pixels relative to the process target pixel, and outputs the parallaxes dNj to the filter processing section 3633.

The filter processing section 3633 performs a filtering process on the cost volume calculated by the local match processing section 361, by using the weights for the peripheral pixels calculated by the weight calculation processing section 3631 and using the parallaxes in the peripheral pixels calculated by the peripheral parallax calculation processing section 3632. By using the weight W_{i,j} for a pixel j in the peripheral region of the process target pixel i calculated by the weight calculation processing section 3631 and using the parallax dNj in the pixel j in the peripheral region of the process target pixel i, the filter processing section 3633 calculates the cost volume having undergone the filtering process, on the basis of Expression (22).

[Math. 9]

CN_{i,d}=ΣⱼW_{i,j}·C_{j,dNj} (22)

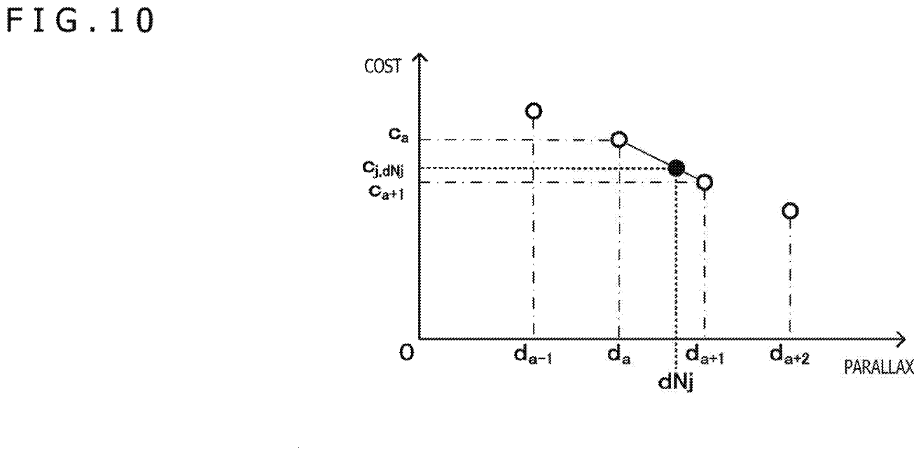

The cost volume of a peripheral pixel is calculated for each parallax d, and the parallax d is a pixel unit value and is an integer value. The parallax dNj in a peripheral pixel calculated on the basis of Expression (20) is not limited to integer values. Thus, in the case where the parallax dNj is not an integer value, the filter processing section 3633 calculates a cost C_{j,dNj} at the parallax dNj by using a cost volume obtained at a parallax close to the parallax dNj. FIG. 10 is a diagram for explaining operation of calculating the cost C_{j,dNj} at the parallax dNj. For example, through fraction processing of the parallax dNj, the filter processing section 3633 obtains a parallax dₐ by rounding down digits after the decimal point and obtains a parallax dₐ₊₁ by rounding up digits after the decimal point. Further, the filter processing section 3633 obtains a cost C_{j,dNj} at the parallax dNj through a linear interpolation using a cost Cₐ at the parallax dₐ and a cost Cₐ₊₁ at the parallax dₐ₊₁.

The filter processing section 3633 obtains a cost CN_{i,d} in the process target pixel on the basis of Expression (22) by using the weights for respective peripheral pixels calculated by the weight calculation processing section 3631 and the costs C_{j,dNj} in the parallax dNj at each of the peripheral pixels calculated by the peripheral parallax calculation processing section 3632. Further, the filter processing section 3633 calculates the cost CN_{i,d} for each parallax by regarding each pixel as a process target pixel. In the manner described so far, the filter processing section 3633 performs cost adjustment processing on a cost volume by using a relationship between the normal line information, the positions, and the luminances of a process target pixel and a peripheral pixel such that a parallax at which the similarity becomes maximum in variation of the cost due to the difference in parallaxes is emphasized. The filter processing section 3633 outputs the cost volume having undergone the cost adjustment processing, to the minimum value search processing section 365.

It is to be noted that, when the weight W_{i,j} is “1” in Expression (22) or (25), the filter processing section 3633 performs the cost adjustment processing through the filtering process based on the normal line information. Also, when the weight W_{i,j} calculated on the basis of Expression (19) is used, the cost adjustment processing is performed through the filtering process based on the normal line information and a distance in the plane direction at the same parallax. Furthermore, when the weight W_{i,j} calculated on the basis of Expression (20) is used, the cost adjustment processing is performed through the filtering process based on the normal line information, a distance in the plane direction at the same parallax, and the luminance change.

The minimum value search processing section 365 detects, on the basis of the cost volume having undergone the filtering process, a parallax at which image similarity becomes maximum. In the cost volume, a cost at each parallax is indicated for each pixel, and, when the cost is smaller, the similarity is higher, as described above. Therefore, the minimum value search processing section 365 detects, for each pixel, a parallax at which the cost becomes minimum.

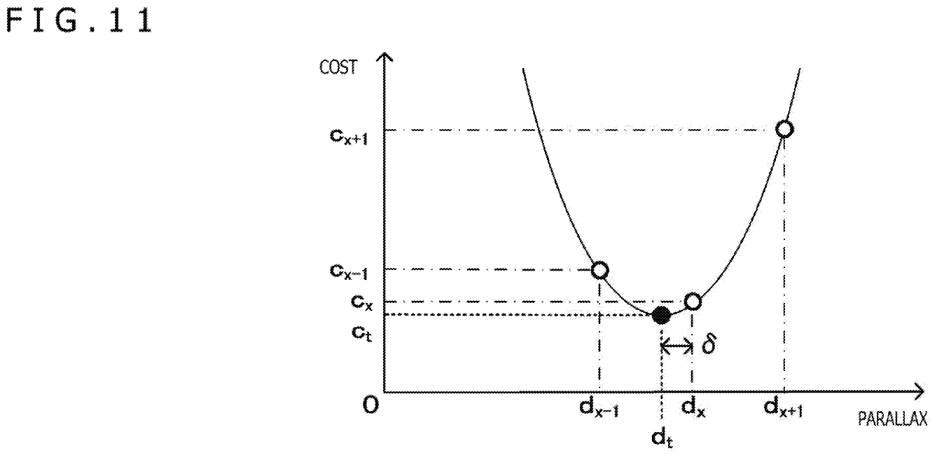

FIG. 11 is a diagram for explaining operation of detecting a parallax at which the cost becomes minimum. FIG. 11 depicts a case where a parallax at which the cost becomes minimum is detected by using parabola fitting.

The minimum value search processing section 365 performs parabola fitting by using costs in successive parallax ranges including a minimum value from parallax-based costs in a target pixel. For example, by using costs in successive parallax ranges centered on a parallax dₓ having the minimum cost Cₓ of the costs calculated for respective parallaxes, that is, a cost Cₓ₋₁ at a parallax dₓ₋₁ and a cost cₓ₊₁ at a parallax dₓ₊₁, the minimum value search processing section 365 obtains, as a parallax in a target pixel, a parallax dₜ further separated from the parallax dₓ by a displacement amount δ such that the cost becomes minimum on the basis of Expression (23). Thus, the parallax dₜ having decimal precision is calculated from the parallax d the unit of which is an integer, and is outputted to the depth calculating section 37.

$$\begin{matrix}[ Math . 10 ] & \\ δ = \frac{1}{2} \cdot \frac{{C}_{x - 1} - {C}_{x + 1}}{{C}_{x + 1} - 2 {C}_{x} + {C}_{x - 1}} & ( 23 )\end{matrix}$$

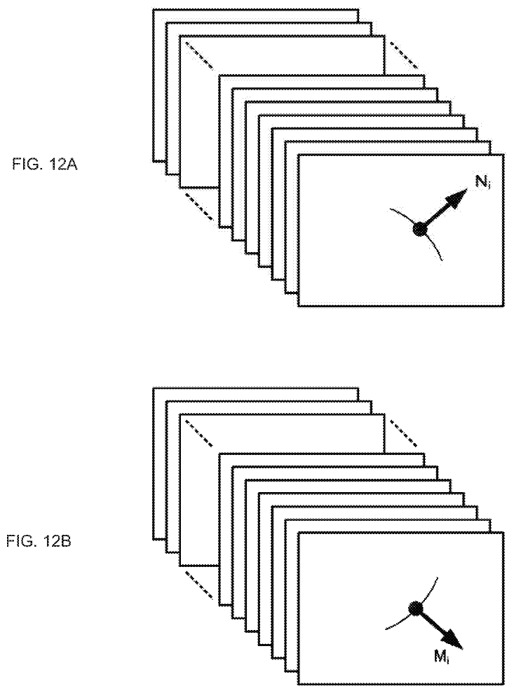

In addition, the parallax detecting section 36 may detect a parallax by including indefiniteness among normal lines. In this case, the peripheral parallax calculation processing section 3632 calculates the parallax dNj in the aforementioned manner by using the normal line information Ni indicating one of normal lines having indefiniteness thereamong. Further, by using normal line information Mi indicating the other normal line, the peripheral parallax calculation processing section 3632 calculates a parallax dMj on the basis of Expression (24), and outputs the parallax dMj to the filter processing section 3633. FIG. 12 depicts a case of having indefiniteness among normal lines. It is assumed that the normal line information Ni and the normal line information Mi having the indefiniteness of 90 degrees are given, for example. It is to be noted that FIG. 12(a) depicts a normal direction indicated by the normal line information Ni in a target pixel, and FIG. 12(b) depicts a normal line direction indicated by the normal line information Mi in a target pixel.

$$\begin{matrix}[ Math . 11 ] & \\ dMj = di * \frac{{M}_{i , x} * {x}_{i} + {M}_{i , y} * {y}_{i} + {M}_{i , z} * f}{{M}_{i , x} * {x}_{j} + {M}_{i , y} * {y}_{j} + {M}_{i , z} * f} & ( 24 )\end{matrix}$$

In the case of performing a filtering process involving normal-line indefiniteness, the filter processing section 3633 performs the cost adjustment processing indicated in Expression (25) on each pixel as a process target pixel, by using the weight for each peripheral pixel calculated by the weight calculation processing section 3631 and the parallax dMj in the peripheral pixel calculated by the peripheral parallax calculation processing section 3632. The filter processing section 3633 outputs the cost volume having undergone the cost adjustment processing, to the minimum value search processing section 365.

[Math. 12]

CM_{i,d}=ΣⱼW_{i,j}·C_{j,dMj} (25)

The minimum value search processing section 365 detects, for each pixel, a parallax at which the cost becomes minimum on the basis of the cost volume having undergone the filtering process based on the normal line information N and the cost volume having undergone the filtering process based on the normal line information M.

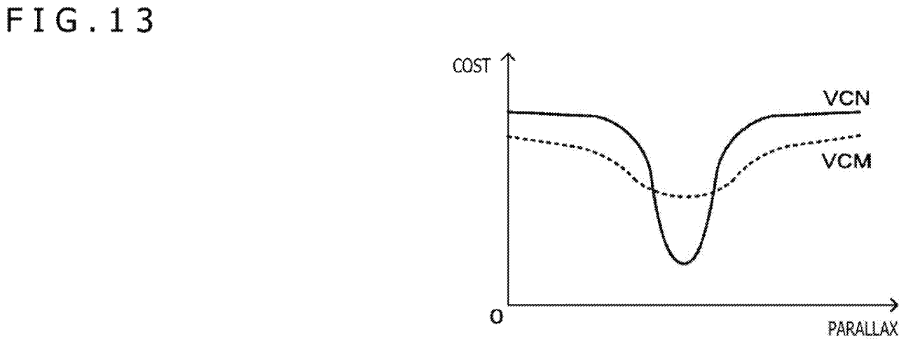

FIG. 13 depicts an example of a parallax-based cost in a process target pixel. It is to be noted that a solid line VCN indicates a cost having undergone the filtering process based on the normal line information Ni, and a broken line VCM indicates a cost having undergone the filtering process based on the normal line information Mi. In this case, a cost volume at which the parallax-based cost becomes minimum is a cost volume having undergone the filtering process based on the normal line information Ni. Accordingly, by use of the cost volume having undergone the filtering process based on the normal line information Ni, a parallax dt having decimal precision is calculated from a parallax-based cost based on a parallax at which the parallax-based cost in the process target pixel becomes minimum.

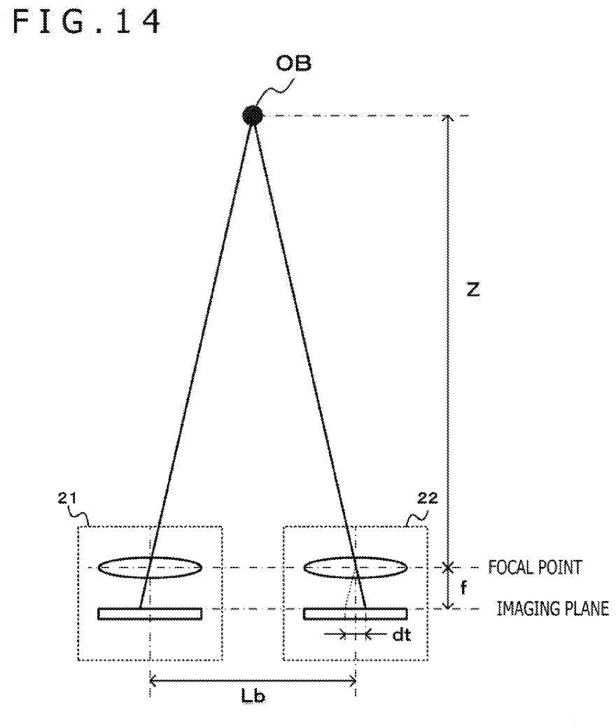

The depth calculating section 37 generates depth information on the basis of a parallax detected by the parallax detecting section 36. FIG. 14 depicts arrangement of the imaging section 21 and the imaging section 22. The distance between the imaging section 21 and the imaging section 22 is defined as a baseline length Lb, and the imaging section 21 and the imaging section 22 each have a focal distance f. The depth calculating section 37 performs, for each pixel, calculation of Expression (26) by using the baseline length Lb, the focal distance f, and the parallax dt detected by the parallax detecting section 36, and generates, as the depth information, a depth map in which depths Z of respective pixels are indicated.

Z=Lb×f/dt (26)

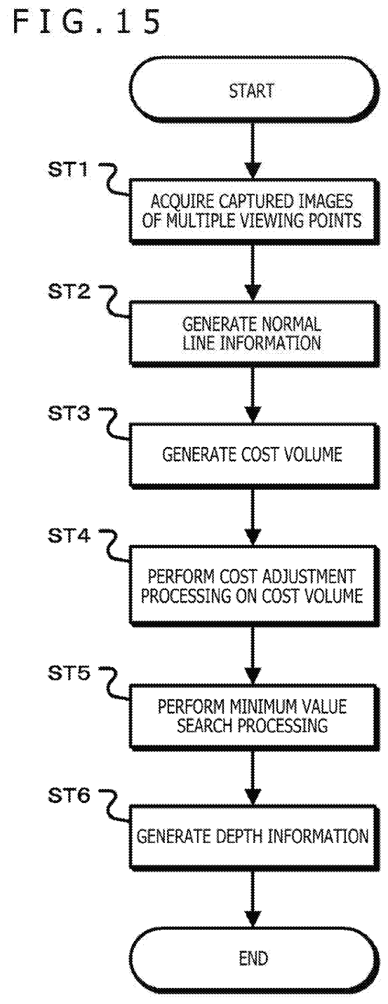

FIG. 15 is a flowchart depicting operation of the image processing device. At step ST1, the image processing device acquires captured images taken from a plurality of viewpoints. The image processing device 30 acquires, from the imaging device 20, image signals of captured multi-viewpoint images including a polarization image generated by the imaging sections 21 and 22. Then, the process proceeds to step ST2.

At step ST2, the image processing device generates normal line information. The image processing device 30 generates normal line information indicating a normal direction in each pixel on the basis of the polarization images acquired from the imaging device 20. Then, the process proceeds to step ST3.

At step ST3, the image processing device generates a cost volume. The image processing device 30 performs a local matching process by using the image signals of a captured polarization image and captured images taken from a viewpoint that is different from that of the captured polarization image acquired from the imaging device 20, and calculates, for each parallax, a cost indicating the similarity, in each pixel, between the images. The image processing device 30 generates a cost volume calculated for each parallax so as to indicate costs of pixels. Then, the process proceeds to step ST4.

At step ST4, the image processing device performs cost adjustment processing on the cost volume. By using the normal line information generated at step ST2, the image processing device 30 calculates a parallax in a pixel in a peripheral region of a process target pixel. Further, the image processing device 30 calculates a weight according to the normal line information, the positions, and the luminances of the process target pixel and the peripheral pixel. Moreover, by using the parallax in the pixel in the peripheral region or using the parallax in the pixel in the peripheral region and the weight for the process target pixel, the image processing device 30 performs the cost adjustment processing on the cost volume such that the parallax at which the similarity becomes maximum is emphasized. Then, the process proceeds to step ST5.

At step ST5, the image processing device performs minimum value search processing. The image processing device 30 acquires a parallax-based cost in a target pixel from the cost volume having undergone the filtering process, and detects a parallax at which the cost becomes minimum. In addition, the image processing device 30 regards each pixel as a target pixel, and detects, for each pixel, a parallax at which the cost becomes minimum. Then, the process proceeds to step ST6.

At step ST6, the image processing device generates depth information. The image processing device 30 calculates a depth for each pixel on the basis of the focal distance of the imaging sections 21 and 22, a baseline length representing the distance between the imaging section 21 and the imaging section 22, and the minimum cost parallax detected for each pixel at step ST5, and generates depth information indicating depths of respective pixels. It is to be noted that step ST2 may be followed by step ST3, or step ST3 may be followed by step ST2.

As explained so far, the first embodiment enables detection of a parallax for each pixel with higher precision than detection of a parallax enabled by a local matching process. In addition, with use of the detected precise parallax, depth information in each pixel can be generated with precision, whereby a precise depth map can be obtained without use of projection light, etc.

### 2. Second Embodiment

### 2-1. Configuration According to Second Embodiment

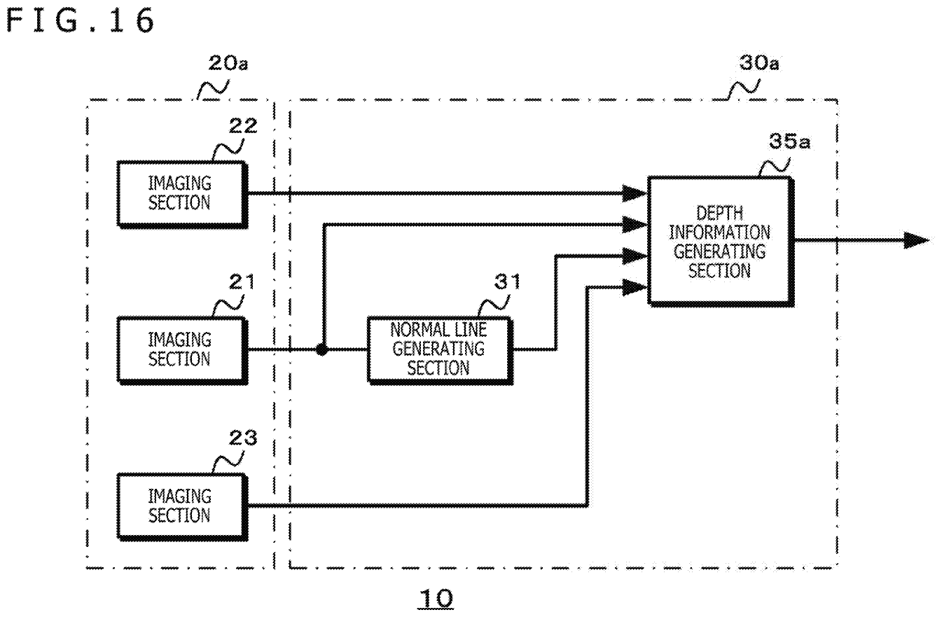

FIG. 16 depicts a configuration of a second embodiment of the information processing system according to the present technology. An information processing system 10a includes an imaging device 20a and an image processing device 30a. The imaging device 20a includes imaging sections 21, 22, and 23. The image processing device 30a includes the normal line information generating section 31 and a depth information generating section 35a.

The imaging section 21 outputs, to the normal line information generating section 31 and the depth information generating section 35a, a polarization image signal obtained by capturing an image of a desired object. Further, the imaging section 22 outputs, to the depth information generating section 35a, a non-polarization image signal or a polarization image signal obtained by capturing an image of the desired object from a viewpoint that is different from that of the imaging section 21. Moreover, the imaging section 23 outputs, to the depth information generating section 35a, a non-polarization image signal or a polarization image signal obtained by capturing an image of the desired object from a viewpoint that is different from the viewpoint of the imaging sections 21 and 22.

The normal line information generating section 31 of the image processing device 30a generates, for each pixel, normal line information indicating a normal direction on the basis of the polarization image signal supplied from the imaging section 21, and outputs the normal line information to the depth information generating section 35a.

The depth information generating section 35a calculates, for each pixel and each parallax, a cost representing the similarity between images by using two image signals taken from different viewpoints and supplied from the imaging section 21 and the imaging section 22, and generates a cost volume. Further, the depth information generating section 35a calculates, for each pixel and each parallax, a cost representing the similarity between images by using two image signals taken from different viewpoints and supplied from the imaging section 21 and the imaging section 23, and generates a cost volume. Moreover, the depth information generating section 35a performs cost adjustment processing on each of the cost volumes by using the image signal supplied from the imaging section 21 and using the normal line information generated by the normal line information generating section 31. Further, by using the parallax-based costs of a parallax detection target pixel, the depth information generating section 35a detects, from the cost volumes having undergone the cost adjustment processing, a parallax at which the similarity becomes maximum. The depth information generating section 35a calculates a depth of each pixel from the detected parallax and from the baseline length and the focal distance between the imaging section 21 and the imaging section 22, and generates depth information.

### 2-2. Operation of Each Section

Next, operation of each section of the imaging device 20a will be explained. The configurations of the imaging sections 21 and 22 are similar to those in the first embodiment. The configuration of the imaging section 23 is similar to that of the imaging section 22. The imaging section 21 outputs a generated polarization image signal to the normal line information generating section 31 of the image processing device 30a. Further, the imaging section 22 outputs a generated image signal to the image processing device 30a. In addition, the imaging section 23 outputs a generated image signal to the image processing device 30a.

The configuration of the normal line information generating section 31 of the image processing device 30a is similar to that in the first embodiment. The normal line information generating section 31 generates normal line information on the basis of a polarization image signal. The normal line information generating section 31 outputs the generated normal line information to the depth information generating section 35a.

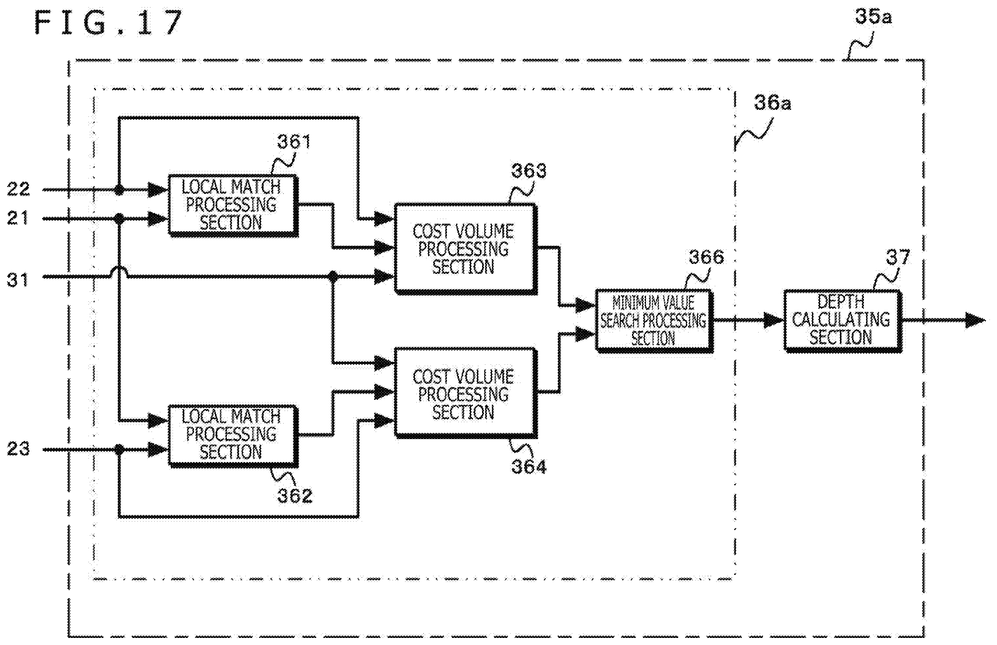

FIG. 17 depicts a configuration of the depth information generating section 35a. The depth information generating section 35a includes a parallax detecting section 36a and the depth calculating section 37. In addition, the parallax detecting section 36a includes local match processing sections 361 and 362, cost volume processing sections 363 and 364, and a minimum value search processing section 366.

The configuration of the local match processing section 361 is similar to that in the first embodiment. By using captured images obtained by the imaging sections 21 and 22, the local match processing section 361 calculates, for each pixel in one of the captured images, the similarity in a corresponding point in the other captured image, and generates a cost volume. The local match processing section 361 outputs the generated cost volume to the cost volume processing section 363.

The configuration of the local match processing section 362 is similar to that of the local match processing section 361. By using the captured images obtained by the imaging sections 21 and 23, the local match processing section 362 calculates, for each pixel in one of the captured images, the similarity in a corresponding point in the other captured image, and generates a cost volume. The local match processing section 362 outputs the generated cost volume to the cost volume processing section 364.

The configuration of the cost volume processing section 363 is similar to that in the first embodiment. The cost volume processing section 363 performs cost adjustment processing on the cost volume generated by the local match processing section 361 such that a parallax can be detected with high precision, and outputs the cost volume having undergone the cost adjustment processing to the minimum value search processing section 366.

The configuration of the cost volume processing section 364 is similar to that of the cost volume processing section 363. The cost volume processing section 364 performs cost adjustment processing on the cost volume generated by the local match processing section 362 such that a parallax can be detected with high precision, and outputs the cost volume having undergone the cost adjustment processing to the minimum value search processing section 366.

As in the first embodiment, the minimum value search processing section 366 detects, for each pixel, a most similar parallax, that is, a parallax at which the minimum value of the similarity is indicated, on the basis of the cost volume having undergone the cost adjustment. In addition, as in the first embodiment, the depth calculating section 37 generates depth information on the basis of the parallax detected by the parallax detecting section 36.

Similar to the first embodiment, the second embodiment enables detection of a parallax for each pixel with high precision, whereby a precise depth map can be obtained. In addition, according to the second embodiment, a parallax can be detected by using not only image signals obtained by the imaging sections 21 and 22 but also an image signal obtained by the imaging section 23. This more reliably enables precise detection of a parallax for each pixel, compared to the case where a parallax is calculated on the basis of image signals obtained by the imaging sections 21 and 22.

Further, the imaging sections 21, 22, and 23 may be arranged side by side in one direction, or may be arranged in two or more directions. For example, in the imaging device 20a, the imaging section 21 and the imaging section 22 are horizontally arranged while the imaging section 21 and the imaging section 23 are vertically arranged. In this case, for an object part for which precise detection of a parallax is difficult with image signals obtained by imaging sections that are arranged side by side in the horizontal direction, precise detection of the parallax can be accomplished on the basis of image signals obtained by imaging sections that are arranged side by side in the vertical direction.

### 3. Other Embodiments

In the aforementioned embodiments, detection of a parallax and generation of depth information with use of image signals that are obtained without any color filter, have been explained. However, the image processing device may have a color mosaic filter or the like provided to the imaging sections, and accomplish detection of a parallax and generation of depth information with use of color image signals generated by the imaging sections. In this case, it is sufficient for the image processing device to perform demosaic processing by using image signals generated by the imaging sections to generate image signals for respective color components and to use pixel luminance values calculated from the image signals for the respective color components, for example. In addition, the image processing device generates normal line information by using pixel signals of polarization pixels that are generated by the imaging sections and that have the same color components.

### 4. Examples of Application

The technology according to the present disclosure is applicable to various products. For example, the technology according to the present disclosure may be implemented as a device mounted on a mobile body which is any one of automobiles, electric automobiles, hybrid electric automobiles, motorcycles, bicycles, personal mobilities, airplanes, drones, ships, robots, and the like.

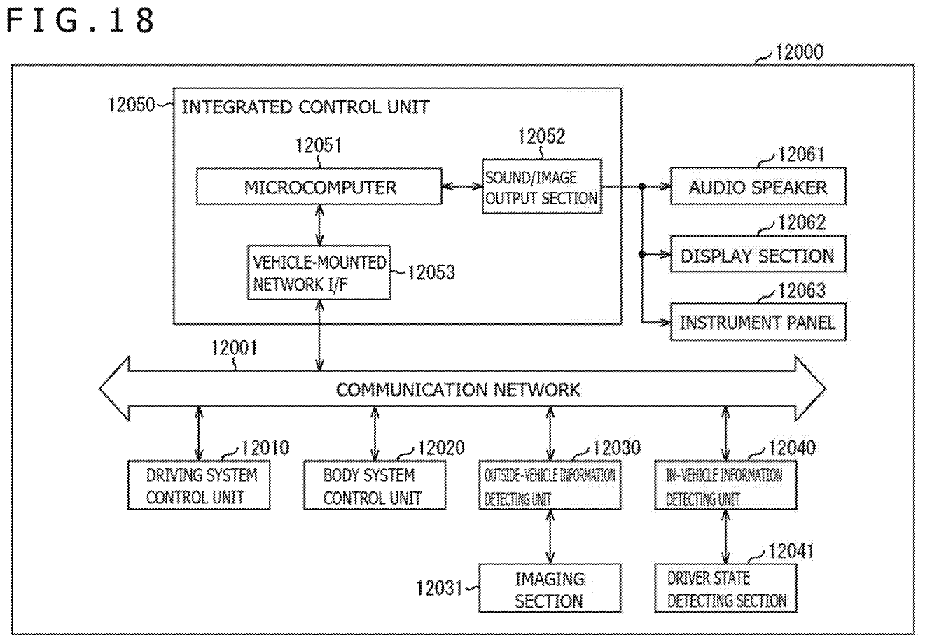

FIG. 18 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 18, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automatic driving, which makes the vehicle to travel autonomously without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 18, an audio speaker 12061, a display section 12062, and an instrument panel 12063 are illustrated as the output device. The display section 12062 may, for example, include at least one of an on-board display and a head-up display.

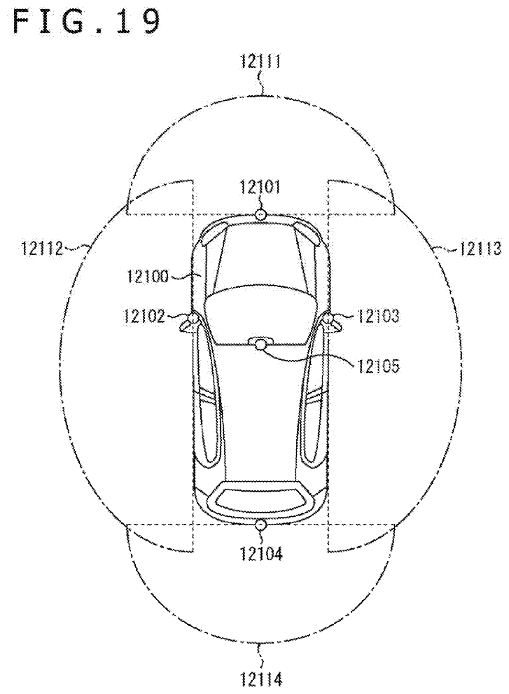

FIG. 19 is a diagram depicting an example of the installation position of the imaging section 12031.

In FIG. 19, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 19 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automatic driving that makes the vehicle travel autonomously without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

One example of a vehicle control system to which the technology according to the present disclosure is applicable has been explained above. The imaging devices 20 and 20a of the technology according to the present disclosure is applicable to the imaging section 12031, etc., among the components in the above explanation. The image processing devices 30 and 30a of the technology according to the present disclosure is applicable to the outside-vehicle information detecting unit 12030, among the components in the above explanation. Accordingly, when the technology according to the present disclosure is applied to a vehicle control system, depth information can be acquired with precision. Thus, when the three-dimensional shape of an object is recognized with use of the acquired depth information, information necessary to lessen fatigue of a driver or necessary to perform automatic driving can be acquired with high precision.

The series of processes described herein can be executed by hardware, software, or a combination thereof. In a case where the processes are executed by software, a program in which a process sequence is recorded can be executed after being installed into a memory incorporated in dedicated hardware of a computer. Alternatively, the program can be executed after being installed into a general-purpose computer that is capable of executing various processes.

For example, the program may be previously recorded in a hard disk, an SSD (Solid State Drive), or a ROM (Read Only Memory), as a recording medium. Alternatively, the program can be temporarily or persistently stored (recorded) in a removal recording medium such as a flexible disc, a CD-ROM (Compact Disc Read Only Memory), an MO (Magneto optical) disc, a DVD (Digital Versatile Disc), a BD (Blu-Ray Disc (registered trademark)), a magnetic disc, or a semiconductor memory card. Such a removable recording medium can be provided as what is called package software.

Alternatively, the program may be not installed into the computer from the removable recording medium, but transferred from a download site to the computer in a wireless/wired manner over a network such as a LAN (Local Area Network) or the Internet. The computer can receive the program thus transferred, and install the program into an internal recording medium such as a hard disc.

It is to be noted that the effects described herein are just examples, and thus, are not limitative. Any additional effect, which is not described herein, may be provided. In addition, the present technology should not be interpreted within the aforementioned embodiments. These technical embodiments disclose the present technology in exemplification thereof. It is obvious that a person skilled in the art can modify the embodiments or provide a substitute therefor within the scope of the gist of the present technology. That is, in order to assess the gist of the present technology, the claims should be taken into consideration.

The image processing device according to the present technology can have the following configurations.

(1)

An imaging processing device including:
a parallax detecting section that performs, by using normal line information in respective pixels based on a polarization image, cost adjustment processing on a cost volume indicating, for each pixel and each parallax, a cost corresponding to a similarity among multi-viewpoint images including the polarization image, and detects, from the cost volume having undergone the cost adjustment processing, a parallax at which the similarity becomes maximum, by using parallax-based costs of a parallax detection target pixel.
   (2)

The image processing device according to (1), in which
the parallax detecting section performs the cost adjustment processing at each parallax, and
in the cost adjustment processing, cost adjustment of the parallax detection target pixel is performed on a basis of a cost that is calculated, with use of the normal line information in the parallax detection target pixel, for a pixel in a peripheral region based on the parallax detection target pixel.
   (3)

The image processing device according to (2), in which
the parallax detecting section weights the cost calculated for the pixel in the peripheral region, in accordance with a normal line difference between normal line information in the parallax detection target pixel and normal line information in the pixel in the peripheral region.
   (4)

The image processing device according to (2) or (3), in which
the parallax detecting section weights the cost calculated for the pixel in the peripheral region, in accordance with a distance between the parallax detection target pixel and the pixel in the peripheral region.
   (5)

The image processing device according to any one of (2) to (4), in which
the parallax detecting section weights the cost calculated for the pixel in the peripheral region, in accordance with a difference between a luminance value of the parallax detection target pixel and a luminance value of the pixel in the peripheral region.
   (6)

The image processing device according to any one of (1) to (5), in which
the parallax detecting section performs the cost adjustment processing for each of normal line directions among which indefiniteness is generated on a basis of the normal line information, and detects a parallax at which the similarity becomes maximum, by using the cost volume having undergone the cost adjustment processing performed for each of the normal line directions.
   (7)

The image processing device according to any one of (1) to (6), in which
the cost volume is generated with each parallax used as a prescribed pixel unit, and
on a basis of a cost in a prescribed parallax range based on a parallax of a prescribed pixel unit at which the similarity becomes maximum, the parallax detecting section detects a parallax at which the similarity becomes maximum with a resolution higher than the prescribed pixel unit.
   (8)

The image processing device according to any one of (1) to (7), further including:
a depth information generating section that generates depth information on a basis of the parallax detected by the parallax detecting section.

### INDUSTRIAL APPLICABILITY

With the image processing device, the image processing method, the program, and the information processing system according to the present technology, cost adjustment processing is performed on a cost volume indicating, for each pixel and each parallax, costs each corresponding to the similarity among multi-viewpoint images including a polarization image, with use of normal line information in each pixel based on the polarization image. From the cost volume having undergone the cost adjustment processing, a parallax at which the similarity becomes maximum is detected with use of the parallax-based costs of a parallax detection target pixel. Thus, a parallax can be detected with high precision almost without the influences of an object shape, an image capturing condition, and the like. Accordingly, the present technology is suited for apparatuses, etc., that need to detect three-dimensional shapes with precision.

### REFERENCE SIGNS LIST

10, 10a . . . Information processing system
20, 20a . . . Imaging device
21, 22, 23 . . . Imaging section
30, 30a . . . Image processing device
31 . . . Normal line information generating section
35, 35a . . . Depth information generating section
36, 36a . . . Parallax detecting section
37 . . . Depth calculating section
211 . . . Camera block
212 . . . Polarization plate
213 . . . Image sensor
214 . . . Polarizer
361, 362 . . . Local match processing section
363, 364 . . . Cost volume processing section
3631 . . . Weight calculation processing section
3632 . . . Peripheral parallax calculation processing section
3633 . . . Filter processing section
365, 366 . . . Minimum value search processing section

1. An image processing device comprising:
a parallax detecting section that performs, by using normal line information in respective pixels based on a polarization image, cost adjustment processing on a cost volume indicating, for each pixel and each parallax, a cost corresponding to a similarity among multi-viewpoint images including the polarization image, and detects, from the cost volume having undergone the cost adjustment processing, a parallax at which the similarity becomes maximum, by using parallax-based costs of a parallax detection target pixel.

2. The image processing device according to claim 1, wherein
the parallax detecting section performs the cost adjustment processing at each parallax, and
in the cost adjustment processing, cost adjustment of the parallax detection target pixel is performed on a basis of a cost that is calculated, with use of the normal line information in the parallax detection target pixel, for a pixel in a peripheral region based on the parallax detection target pixel.

3. The image processing device according to claim 2, wherein
the parallax detecting section weights the cost calculated for the pixel in the peripheral region, in accordance with a normal line difference between normal line information in the parallax detection target pixel and normal line information in the pixel in the peripheral region.

4. The image processing device according to claim 2, wherein
the parallax detecting section weights the cost calculated for the pixel in the peripheral region, in accordance with a distance between the parallax detection target pixel and the pixel in the peripheral region.

5. The image processing device according to claim 2, wherein
the parallax detecting section weights the cost calculated for the pixel in the peripheral region, in accordance with a difference between a luminance value of the parallax detection target pixel and a luminance value of the pixel in the peripheral region.

6. The image processing device according to claim 1, wherein
the parallax detecting section performs the cost adjustment processing for each of normal line directions among which indefiniteness is generated on a basis of the normal line information, and detects a parallax at which the similarity becomes maximum, by using the cost volume having undergone the cost adjustment processing performed for each of the normal line directions.

7. The image processing device according to claim 1, wherein
the cost volume is generated with each parallax used as a prescribed pixel unit, and
on a basis of a cost in a prescribed parallax range based on a parallax of a prescribed pixel unit at which the similarity becomes maximum, the parallax detecting section detects a parallax at which the similarity becomes maximum with a resolution higher than the prescribed pixel unit.

8. The image processing device according to claim 1, further comprising:
a depth information generating section that generates depth information on a basis of the parallax detected by the parallax detecting section.

9. An image processing method comprising:
performing, by using normal line information in respective pixels based on a polarization image, cost adjustment processing on a cost volume indicating, for each pixel and each parallax, a cost corresponding to a similarity among multi-viewpoint images including the polarization image, and detecting, from the cost volume having undergone the cost adjustment processing, a parallax at which the similarity becomes maximum, by using parallax-based costs of a parallax detection target pixel.

10. A program for causing a computer to process multi-viewpoint images including a polarization image, the program for causing the computer to execute:
a procedure of performing, by using normal line information in respective pixels based on the polarization image, cost adjustment processing on a cost volume indicating, for each pixel and each parallax, a cost corresponding to a similarity among the multi-viewpoint images including the polarization image; and
a procedure of detecting, from the cost volume having undergone the cost adjustment processing, a parallax at which the similarity becomes maximum, by using parallax-based costs of a parallax detection target pixel.

11. An information processing system comprising:
an imaging section that acquires multi-viewpoint images including a polarization image;
a parallax detecting section that performs, by using normal line information in respective pixels based on the polarization image, cost adjustment processing on a cost volume indicating, for each pixel and each parallax, a cost corresponding to a similarity among the multi-viewpoint images including the polarization image, and detects, from the cost volume having undergone the cost adjustment processing, a parallax at which the similarity becomes maximum, by using parallax-based costs of a parallax detection target pixel; and
a depth information generating section that generates depth information on a basis of the parallax detected by the parallax detecting section.
